(19) United States
(12) Patent Application Publication
(10) Pub. No.: US 2001/0026221 A1
(43) Pub. Date: Oct. 4, 2001

(54) Emergency notification and rescue request system

(75) Inventor: Katsunori Toyota, Tokyo (JP)

Correspondence Address: Alan H. MacPherson, SKJERVEN, MORRILL, MacPHERSON,, FRANKLIN & FRIEL LLP, 25 Metro Drive, Suite 700, San Jose, CA, 95110, US

(73) Assignee: Kabushiki Kaisha Alpha Tsushin

(21) Appl. No.: 09/745,975

(22) Filed: Dec. 21, 2000

(30) Foreign Application Priority Data
Apr. 4, 2000 (JP) 2000-101666

(51) Int. Cl. G08B 23/00

(52) U.S. Cl. 340/573.1; 340/531; 379/40; 340/573.4

(57) ABSTRACT

In an emergency notification and rescue request system, comprising: a plurality of input terminals for receiving signals from a sensor(s) or from a transmitter operable by a user; an automatic telephone dialer for selectively making a telephone call to a plurality of parties; and a memory for storing a plurality of messages, one or more call receiving parties are set for each of the input terminals and wherein one or more of said plurality of messages can be selectively assigned to each of the set call receiving parties or to each of the set combinations of the call receiving parties and input terminals so that upon a signal input to any one of said input terminals, a telephone call is made to said one or more call receiving parties set for the input terminal to transmit the messages assigned to said call receiving parties.

### TECHNICAL FIELD

The present invention relates to an emergency notification and rescue request system for transmitting a rescue request message to predesignated call receiving parties via telephone line when a situation requiring a rescue effort arises. Particularly, the present invention relates to an emergency notification and rescue request system which is suitable for use in households including blind, handicapped, ill or otherwise infirm members.

### BACKGROUND OF THE INVENTION

Households including infirm members may need to call for a help to rescue teams and neighbors in case of an accident or a sudden worsening of a sickness. Such household members may not be able to call for a help by their own efforts. Therefore, it has been proposed to install a switch in the house to emit an alarm to the outside or to make a call to a rescue team or a neighbor. Alarm systems which operate in conjunction with sensors such as a gas leak sensor or fire sensor have been also known.

However, in case of an accident or a sudden worsening of a sickness, the affected person may not be able to reach the switch or to operate it depending on the position of the affected person at the time of the accident or the sudden worsening of the sickness. Also, even when a telephone call has been made, the disabled person may still be unable to request a help by speech on the phone.

To solve such problems, U.S. Pat. No. 6,084,525 which was issued on Jul. 4, 2000 to the same assignee of the present application, has proposed an alarm system comprising a wristwatch-type radio transmitter worn by a user, an automatic telephone unit which makes a call to a predetermined party or to each of a number of predetermined parties upon receiving a radio signal from the transmitter, and a speech synthesizing unit for pronouncing the address and name of the caller and a distress message. In this way, even if the user is too weak to pick up a telephone or is immobilized due to sickness or an accident, simply by pressing the switch on the wrist band, he can call for a help by telephone, and an accurate and timely rescue effort can be made.

However, in the alarm system disclosed in U.S. Pat. No. 6,084,525, different emergency situations are notified to the same party or plurality of parties. In general, however, different emergency situations such as fire, burglary or sudden worsening of sickness may need different parties to be notified of and deal with the emergency situations. Thus, in this system, a situation may arise in that a party notified of an emergency situation may not be appropriate to deal with the emergency situation and must contact another party capable of dealing with the emergency situation. This could delay the start of the emergency rescue effort.

U.S. Pat. No. 4,821,027 issued to Mallory et al. has disclosed an emergency phone messaging system that can allow different lists of telephone numbers to be dialed for different types of emergency alarm. It is also disclosed in this publication that an emergency message to be transmitted to a list of telephone numbers set for a type of emergency alarm can comprise the type of emergency alarm and a user-changeable prerecorded message including information such as the name of the home owner and its location. The system of Mallory et al, however, can store only one user-changeable message and therefore the same message is transmitted to all the telephone numbers in the list set for each type of emergency alarm. However, different call receiving parties may require different rescue messages even for a same emergency situation. Therefore, in the system of Mallory et al, a message appropriate to one call receiving party could be too concise to provide adequate information to another call receiving party or could be unnecessarily lengthy to yet another call receiving party. Thus, the ability of the system to achieve optimum emergency notification was still insufficient.

### BRIEF SUMMARY OF THE INVENTION

In view of such problems of the prior art and the recognition by the inventors, a primary object of the present invention is to provide an emergency notification and rescue request system that can call for a help, via a telephone network, to appropriate parties with appropriate messages even in the condition where the user cannot utter a voice.

A second object of the present invention is to provide such an emergency notification and rescue request system that can allow a user to easily assign appropriate messages to each of the call receiving parties.

A third object of the present invention is to provide such an emergency notification and rescue request system in a simple configuration and at low cost.

According to the present invention, these and other objects can be accomplished by providing an emergency notification and rescue request system, comprising: a plurality of input terminals for receiving signals from a sensor(s) or from a transmitter operable by a user; an automatic telephone dialer for selectively making a telephone call to a plurality of parties; and a memory for storing a plurality of messages, wherein one or more call receiving parties are set for each of the input terminals and wherein one or more of said plurality of messages can be selectively assigned to each of the set call receiving parties or to each of the set combinations of the call receiving parties and input terminals so that upon a signal input to any one of said input terminals, a telephone call is made to said one or more call receiving parties set for the input terminal to transmit the messages assigned to said call receiving parties.

In this way, since an appropriate rescue request message(s) can be assigned to each of the call receiving parties for various emergency situations, it is possible to achieve optimum emergency notification to each of the call receiving parties, to thereby ensure efficient and reliable emergency notification. Particularly, such an emergency notification and rescue request system can be easily adapted to achieve optimum emergency notification both to a party having an automatic caller identifying system and to a party without such a caller identifying system by assigning no message to said party having the automatic caller identifying system, achieving a higher versatility of the system.

Preferably, the memory stores the information defining the selective assignment of said messages to each of the set call receiving parties or to each of the set combinations of the call receiving parties and input terminals. In this way, the memory need not store all the messages individually made for each of the set combinations of the call receiving parties and input terminals, and thus can reduce the required memory capacity, which leads to a lower manufacturing cost.

Each of said plurality of messages is preferably user-changeable and further preferably, the plurality of messages stored in the memory comprises a plurality of groups of messages so that one or more messages of each of the groups of messages can be selectively assigned to each of the set call receiving parties or to each of the set combinations of the call receiving parties and input terminals. Such categorized groups of messages can allow a user to carry out the assignment of the messages more easily and quickly.

In a typical embodiment, the emergency notification and rescue request system further comprises a signal receiving device connected to one of the plurality of input terminals for receiving a signal from the transmitter operable by the user, wherein the transmitter is user-portable.

Other and further objects, features and advantages of the invention will appear more fully from the following description.

### BRIEF DESCRIPTION OF THE DRAWINGS

Now the present invention is described in the following with reference to the appended drawings, in which:

FIG. 1 is a block diagram showing a configuration of a preferred embodiment of an emergency notification and rescue request system according to the present invention;

FIG. 2a is a top plan view of a main body of the emergency notification and rescue request system according to the present invention, while FIG. 2b is a bottom plan view of the same;

FIG. 3 is a part of a flowchart for showing, in conjunction with FIG. 4, a way of operation of the emergency notification and rescue request system according to the present invention; and

FIG. 4 is a part of a flowchart for showing, in conjunction with FIG. 3, a way of operation of the emergency notification and rescue request system according to the present invention.

### DETAILED DESCRIPTION OF THE PREFERRED EMBODIMENTS

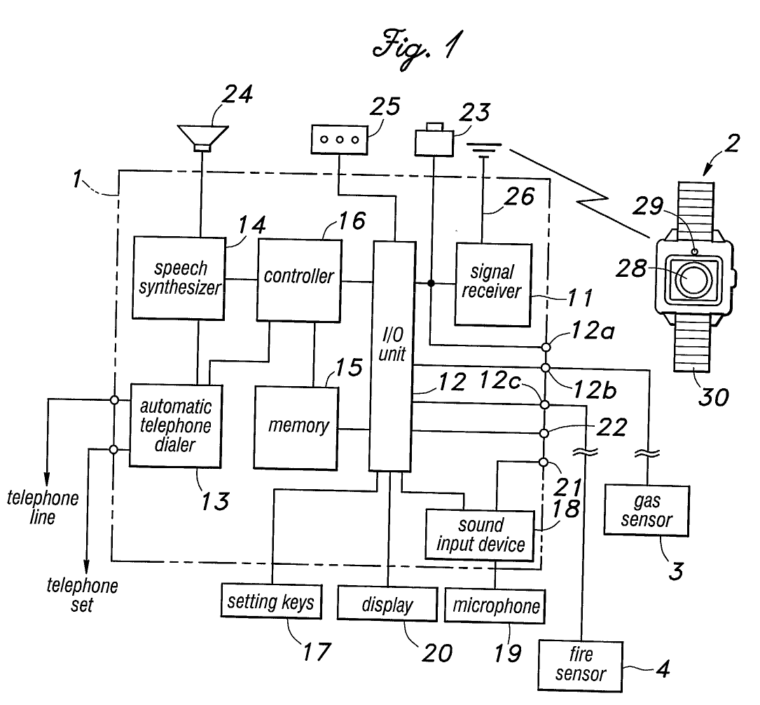

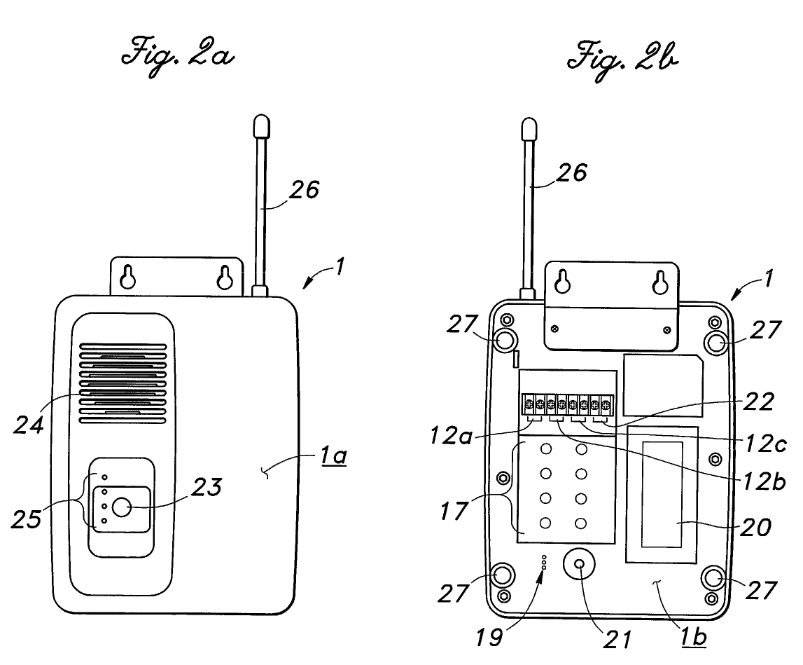

FIG. 1 is a block diagram showing a configuration of a preferred embodiment of an emergency notification and rescue request system according to the present invention. The emergency notification and rescue request system comprises a main body 1 (see also FIGS. 2a and 2b) connected to a telephone line in a room, and a wristwatch-type portable signal transmitter 2.

The main body 1 is provided with a built-in radio signal receiver 11 for receiving a radio signal from the portable signal transmitter 2. The signal receiver 11 is connected to an input/output unit 12 in parallel with an input terminal 12a that is provided on an underside 1a of the main body 1. The input/output unit 12 is further provided with an input terminal 12b connected to a gas sensor 3 positioned at an appropriate place in the house and an input terminal 12c connected to a fire sensor 4 also positioned at an appropriate place in the house (see also FIG. 2b).

The main body 1 further comprises: an automatic telephone dialer 13 for, in response to a signal from the gas sensor 3, fire sensor 4 or portable signal transmitter 2, making a telephone call to predetermined call receiving parties following a later described sequence; a memory device 15, which may consist of an IC chip or the like, for storing a plurality of telephone numbers to be dialed and a plurality of rescue request messages (emergency messages) as well as various settings later described; a speech synthesizer 14 for converting the digitally stored messages into an analogue form for transmission to call receiving parties; and a controller 16 for determining the call receiving parties and the transmitted messages depending on the signal input to the input/output unit 12 and controlling the automatic telephone dialer 13 and the speech synthesizer 14 to execute the emergency notification and rescue request operation.

Also, the main body 1 is equipped with setting keys 17 used for setting call receiving parties (or entering their telephone numbers) for each of the input terminals 12a, 12b and 12c and assigning rescue request messages for each call receiving party set for each input terminal, a sound input device 18 comprising a microphone 19, and a monitor display 20. As shown in FIG. 2b, the setting keys 17, microphone 19 and the display 20 are provided on the usually hidden underside 1b of the main body 1 to prevent inadvertent or false operation thereof.

An external input terminal 21 connected to the sound input device 18 is also provided on the underside 1b of the main body 1 so as to allow a message to be input from a recording device such as a tape recorder. An output terminal 22 is provided adjacent to the input terminals 12a, 12b and 12c for making it possible to operate an alarm sound emitter or a flashing light unit placed outside the room or house in which the main body 1 is situated. The input terminal 12a is provided to allow an additional sensor or the like to be connected in parallel with the built-in signal receiving device 11. Further, a push button switch 23, which is provided on the top side 1a of the main body 1 as shown in FIG. 2a, is connected to the input/output unit 12 in parallel with the signal receiving device 11 and the input terminal 12a so that pressing the switch 23 will trigger a same emergency notifying operation as that triggered by pressing a push button switch 28 of the portable transmitter 2 which will be described in detail later. Also provided on the top side 1a of the main body 1 are a speaker 24 connected to the speech synthesizer 14 so as to allow a user to check the rescue request message when the user sets the message or when the message is transmitted to a call receiving party, and an indicator 25 for indicating the call receiving party during message transmission.

A reference numeral 26 in FIGS. 2a and 2b designates an antenna connected to the signal receiving device 11, and a reference numeral 27 in FIG. 2b designates rubber feet functioning as spacers for preventing the setting keys 17, microphone 19 and display 20 from contacting the surface on which the main body 1 is fixed.

The portable transmitter 2 is provided with a transmission indicator lamp 29 consisting of an LED or the like in addition to the transmission switch 28. When the transmission switch 28 is pressed by the user, a radio signal is transmitted to the signal receiving device 11 and at the same time the transmission indicator lamp 29 is turned on and off. The portable transmitter 2 is also equipped with an elastic stainless band 30 so that the transmitter 2 can be always worn on a wrist of the user.

In the above emergency notification and rescue request system, up to three call receiving parties can be set for each of the input terminals 12a, 12b and 12c (or the emergency types) so that a total of nine call receiving parties can be set at maximum. Further, to each of the call receiving parties set for each of the input terminals 12a, 12b and 12c, the user can selectively assign one of three first category messages and a single second category message stored in the memory device 15. More generally, it is possible to assign (or select) none or at least one messages to each of the call receiving parties set for each of the input terminals from a plurality of stored messages. Of course, the number of input terminals may be more than three. The three first category messages may be preferably prepared (or recorded) by the manufacturer at the factory. However, they may be also prepared by the user by recording the messages through the microphone 19 or the external input terminal 21. The first category messages may comprise, for example, “please help me”, “gas leak occurred”, and “fire occurred”. The second category message may consist of a single user-recorded message including, for example, the name, address and telephone number of the user. Alternatively, more than one second category messages may be stored in the memory 15.

The above setting of the call receiving parties for each signal terminal and selective assignment of the messages to each call receiving party set for each input terminal are stored in the memory device 15 in the main body 1. In this way, the required capacity of the memory device 15 can be significantly reduced compared with the case where the rescue request messages are individually made (or recorded) for each call receiving party set for each input terminal and stored in the memory device 15.

To use the system, first of all, the main body 1 is installed at an appropriate place inside the user's house such as near the telephone line outlet, and then connected to the telephone line as well as to the gas leak sensor 3 and fire sensor 4 which are also placed at appropriate positions. An optional flashing light unit placed outside the house may be also connected to the output terminal 22 of the main body 1. The portable transmitter 2 is worn on the wrist of the user. After the power is supplied to the main body 1, various setup operations are allowed to be performed with the setting keys 17 and the monitor display 20. The setup operations may comprise: recording the second category message through the microphone 19 or the external input terminal 21; entering the telephone numbers of the call receiving parties for each of the input terminals 12a, 12b and 12c; assigning (or selecting) the first and second category messages to each of the call receiving parties; determining, for each of the input terminals 12a, 12b and 12c, whether the emergency notification operation should be continued until the notification has been successfully made to all of the set call receiving parties or the operation should be ended when the notification has been successfully made to one of the set call receiving parties; and determining the maximum number (ten or “no limit”, for example) of repeated dialing operations to the phone number which is “busy” or for other reasons connection cannot be made with; etc. If necessary, it is also possible to record or change the first category messages by using the microphone 19 and the external input terminal 21.

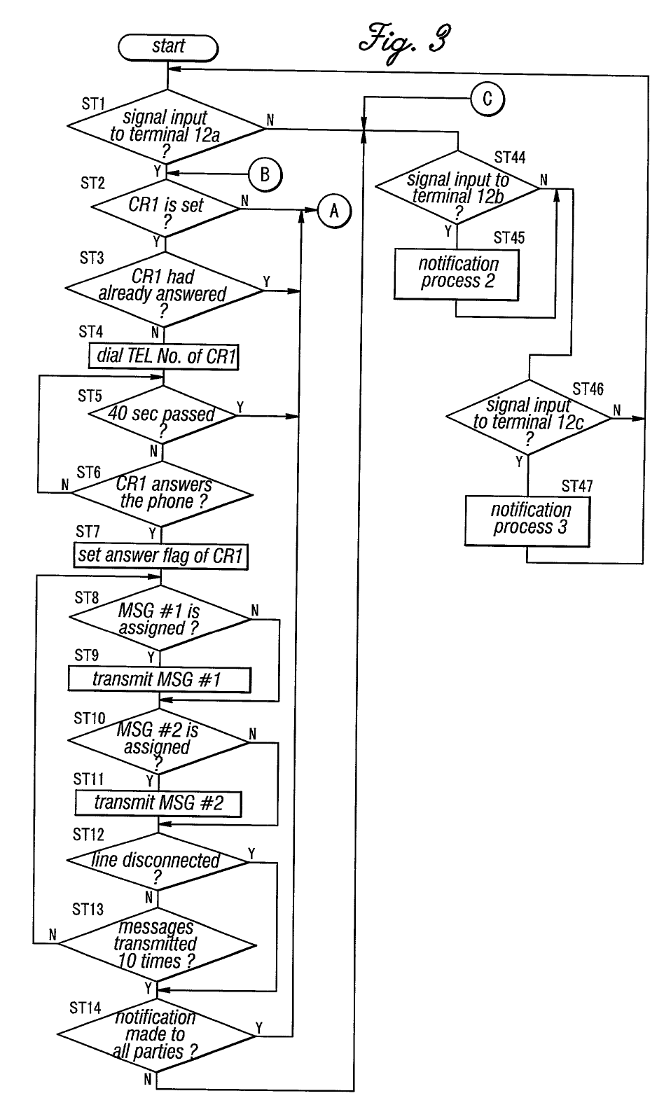

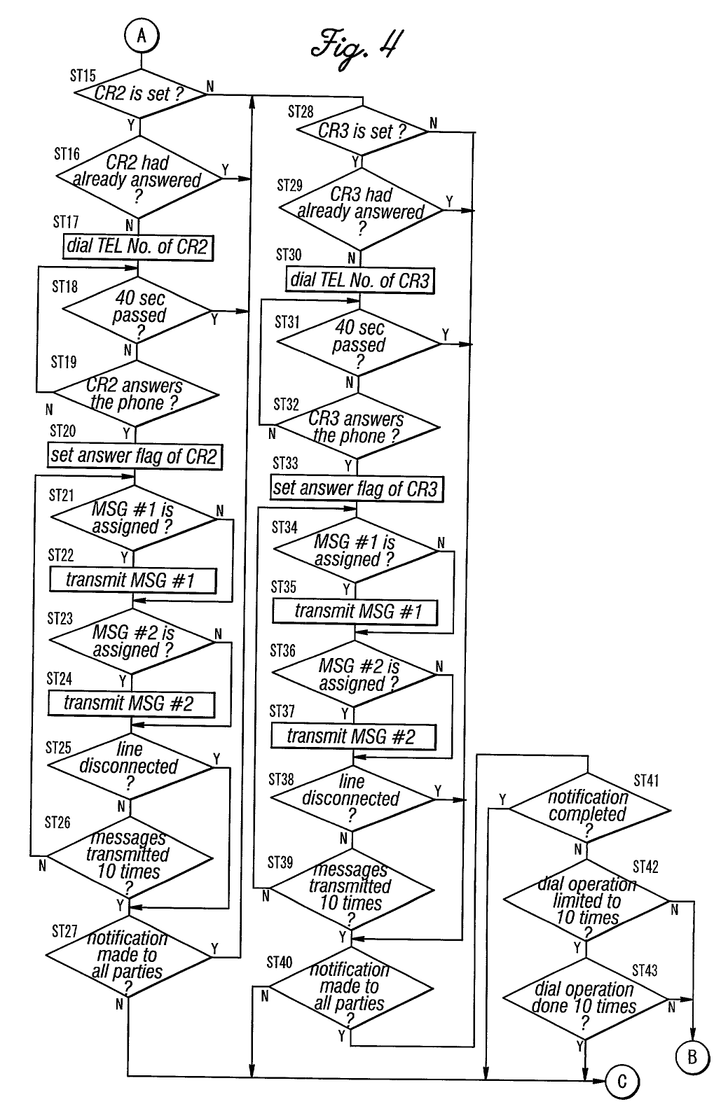

After the setup is completed, the system operates following the flowchart of FIGS. 3 and 4. In this flowchart, steps 1-43 are for the process performed in response to the signal input through the input terminal 12a, steps 44, 45 are for the process performed in response to the signal input through the input terminal 12b, and steps 46, 47 are for the process performed in response to the signal input through the input terminal 12c. Steps 2-14 are for performing emergency notification to a first call receiving party, which is usually assigned with a highest priority, set for the input terminal 12a. Similarly, steps 15-27 are for performing emergency notification to a second highest priority call receiving party set for the input terminal 12a, and steps 28-40 are for performing emergency notification to a third highest priority call receiving party set for the input terminal 12a. It should be understood that the steps 45, 47 (notification processes 2 and 3) for the input terminals 12b and 12c each substantially correspond to the steps 2-43 (notification process 1) for the input terminal 12a except for the setting of the first and second category messages, and thus the detailed explanation of steps 45, 47 is omitted.

In step 1, it is checked if there is a signal input to the input terminal 12a. Specifically, it is checked if the push button switch 28 on the portable transmitter 2 is pressed, if the push button switch 23 on the main body 1 is pressed or if a signal is generated from the sensor connected to the input terminal 12a. If it is determined in step 1 that there is a signal input to the input terminal 12a, the process proceeds to step 2 where it is checked if the first call receiving party (CR1) for the input terminal 12a has been set or not. If the first call receiving party has been set, a dialing is made to the first call receiving party (step 4) and if the receiving party answers the phone, an answer flag associated with the first call receiving party is set to indicate the answering by the call receiving party (steps 6, 7), and then the process proceeds to step 8. If it is determined that the first call receiving party has not been set in step 2 or if 40 seconds has passed without the receiving party's answering the phone in step 5, the process proceeds to step 15 to try the emergency notification to the second call receiving party.

In steps 8-13, the first category message (MSG #1) and the second category message (MSG #2) assigned to the first call receiving party for the input terminal 12a are repeatedly transmitted 10 times or until the call receiving party hangs up the receiver. It should be noted that, as mentioned above, the first and second category messages can be assigned to each call receiving party but not necessarily. For example, one call receiving party may be assigned with either the first category message or the second category message, and another call receiving party may be assigned with neither the first nor the second category message. The latter setting may be suitable to a call receiving party having a system for automatically identifying the call sender.

If it is determined that the call receiving party hangs up the receiver to disconnect the line in step 12 or if it is determined that the messages have been transmitted 10 times in step 13, the process proceeds to step 14 to determine if the setting has been made to continue the emergency notification operation until the notification has been successfully made to all of the set call receiving parties or the setting has been made to end the emergency notification operation when the notification has been successfully made to one of the set call receiving parties. In the former case, the process proceeds to step 15 to notify the emergency situation to the next (second) call receiving party, and in the latter case the process proceeds to step 44 to execute the operation regarding the next (second) input terminal 12b.

The steps 15-27 are substantially identical to the steps 2-14 except for the call receiving party and the first and second category messages transmitted to the call receiving party. Similarly to the steps for the first receiving party, if the second call receiving party (CR2) has not been set (step 15), if the second call receiving party has already answered the phone (step 16), if 40 second has passed without the receiving party's answering the phone (step 18) or if the setting has been made to continue the emergency notifying operation until the notification has been successfully made to all of the set call receiving parties (step 27), the process proceeds to step 28 to notify the emergency situation to the next (third) call receiving party.

The steps 28-40 are substantially identical to the steps 2-14 or the steps 15-27 except for the call receiving party and the first and second category messages transmitted to the call receiving party. If the third call receiving party (CR3) has not been set (step 28), if the third call receiving party has already answered the phone (step 29) or if 40 second has passed without the receiving party's answering the phone (step 31), the process proceeds to step 40 where it is determined if the setting has been made to continue the emergency notification operation until the notification has been successfully made to all of the set call receiving parties or the setting has been made to end the emergency notification operation when the notification has been successfully made to one of the set call receiving parties. In the former case, the process proceeds to step 41, and in the latter case the process proceeds to step 44 to execute the operation regarding the next (second) input terminal 12b.

In step 41, it is determined if all the emergency notification operation regarding (i.e., triggered by the signal input to) the input terminal 12a has been successfully completed, and if this is the case the process proceeds to step 44. If not, the process proceeds to step 42 where it is determined if the maximum number of repetition of the dialing operation has been set to 10. If it is determined that the maximum number of repetition of the dialing operation has been set to 10, the process proceeds to step 43 to check if the dialing operation has been done 10 times and if this is the case the process goes to step 44 to n execute the steps regarding the second input terminal 12b. If it is determined that the maximum number of repetition of the dialing operation has not been limited in step 42 or if it is determined that the dialing operation has not been done 10times yet, the process returns to step 2 to repeat the emergency notifying operation (steps 2-43) to the first to third call receiving parties set for the first input terminal 12a.

In step 44, it is checked if there is a signal input to the input terminal 12b, in other words, it is checked if the sensor connected to the input terminal 12b detects a gas leak. If it is determined in step 44 that there is a signal input to the input terminal 12b, the emergency notifying operation of step 45 is carried out. As mentioned above, the operation of step 45 is substantially identical to that of steps 2-43 except for the up to three call receiving parties set for each input terminal and the first and second category messages selectively assigned to each of the call receiving parties. If the emergency notifying operation of step 45 has been completed, the process proceeds to step 46 to execute the operation regarding the next (third) input terminal 12c.

In step 46, it is checked if there is a signal input to the input terminal 12c, i.e., it is checked if the sensor connected to the input terminal 12c detects a fire. If it is determined in step 46 that there is a signal input to the input terminal 12c, the emergency notifying operation of step 47 is carried out. As mentioned above, the operation of step 47 is substantially identical to that of steps 2-43 except for the up to three call receiving parties set for each input terminal and the first and second category messages selectively assigned to each of the call receiving parties. If the emergency notifying operation of step 47 has been completed, the process goes back to step 1.

Thus, in usual conditions where there is no signal input to the input terminals 12a-12c, the process repeats the steps 1, 44 and 46. And upon receiving a signal input to any one of the input terminals 12a-12c, the above described emergency notifying operation is carried out.

In the following, the above process is described in terms of a concrete embodiment. In the following embodiment, a fire station having a system for automatically identifying the call sender, a friend of the user and a local government welfare office are set as the first, second and third call receiving parties associated with the input terminal 12a, respectively. And the first call receiving party (fire station) is assigned with neither the first nor the second category messages, the second call receiving party (friend) is assigned with the first category message of “please help me” and the second category message including the name, address and telephone number of the user, and the third call receiving party (welfare office) is assigned with no first category message but with the second category message.

As the first, second and third call receiving parties associated with the input terminal 12b, a fire station without a system for automatically identifying the call sender, a gas company and a relative of the user are set, respectively, and each of the call receiving parties are assigned with the first category message of “gas leak occurred” and the second category message (the name, address and telephone number of the user).

Further, as the first, second and third call receiving parties associated with the input terminal 12c, a fire station having a system for automatically identifying the call sender, a friend of the user and a relative of the user are set, respectively. And the first call receiving party (fire station) is assigned with neither the first nor the second category message, the second call receiving party (friend) is assigned with the first category message of “please help me” and the second category message (the name, address and telephone number of the user), and the third call receiving party (relative) is assigned with the first category message of “fire occurred” and the second category message.

In case of an accident or a sudden worsening of a sickness, for example, the user can press the transmission switch 28 on the radio transmitter 2 to emit a radio signal from the transmitter 2. The signal from the transmitter 2 is received by the signal receiver 11 of the main body 1 so that the emergency notifying operation to the first to third call receiving parties set for the input terminal 12a is carried out according to the above settings. This can allow the emergency situation to be readily notified to appropriate parties with appropriate messages, thereby achieving a rescue effort to be started without any delay. Particularly, the emergency notification and rescue request system of the invention can ensure that the emergency situation is easily identified by a party without a caller identifying system and at the same time can achieve a most efficient emergency notification to a party having a caller identifying system.

In case of a gas leak, a signal from the gas leak sensor 3 is input to the input terminal 12b, and the emergency notifying operation to the first to third call receiving parties set for the input terminal 12b is carried out according to the above settings. In this case also, the emergency situation can be readily notified to appropriate parties, and thereby a rescue effort can be started without any delay. Similarly, in case of a fire, a signal from the fire sensor 4 is input to the input terminal 12c, and the emergency notifying operation to the first to third call receiving parties associated with the input terminal 12c is carried out according to the above settings.

As described above, in the emergency notification and rescue request system according to the present invention, since an appropriate rescue request message(s) can be easily assigned to each of the call receiving parties for various emergency situations, it is possible to achieve optimum emergency notification to each of the call receiving parties set for each emergency type, to thereby ensure prompt and reliable emergency notification.

Although the present invention has been described in terms of preferred embodiments thereof, it is obvious to a person skilled in the art that various alterations and modifications are possible without departing from the scope of the present invention which is set forth in the appended claims. For example, in the above embodiment, the first category messages comprised “please help me”, “gas leak occurred”, and “fire occurred”. However, any other suitable messages such as “I have a hearing impairment” or “please call an ambulance for me” may be alternatively or additionally comprised. Further, although the above embodiment only disclosed to selectively assign none or only one of the first category messages to a call receiving party, more than one first category messages may be assigned to a call receiving party to make such a combination of messages as “fire occurred, I have a hearing impairment, please call an ambulance for me”. Such modifications should fall within the scope of the present invention.

1. An emergency notification and rescue request system, comprising:
a plurality of input terminals for receiving signals from a sensor(s) or from a transmitter operable by a user;
an automatic telephone dialer for selectively making a telephone call to a plurality of parties; and
a memory for storing a plurality of messages,
wherein one or more call receiving parties are set for each of the input terminals and wherein one or more of said plurality of messages can be selectively assigned to each of the set call receiving parties or to each of the set combinations of the call receiving parties and input terminals so that upon a signal input to any one of said input terminals, a telephone call is made to said one or more call receiving parties set for the input terminal to transmit the messages assigned to said call receiving parties.

2. An emergency notification and rescue request system according to claim 1, wherein said memory stores information defining the selective assignment of said messages to each of the set call receiving parties or to each of the set combinations of the call receiving parties and input terminals.

3. An emergency notification and rescue request system according to claim 1, wherein each of said plurality of messages is user-changeable.

4. An emergency notification and rescue request system according to claim 1, wherein the plurality of messages stored in the memory comprises a plurality of groups of messages so that one or more messages of each of the groups of messages can be selectively assigned to each of the set call receiving parties or to each of the set combinations of the call receiving parties and input terminals.

5. An emergency notification and rescue request system according to claim 1, further comprising a signal receiving device connected to one of the plurality of input terminals for receiving a signal from the transmitter operable by the user, wherein the transmitter is user-portable.
